(19) United States
(12) Patent Application Publication
(10) Pub. No.: US 2026/0139743 A1
(43) Pub. Date: May 21, 2026

(54) BUTTERFLY VALVE ASSEMBLIES

(71) Applicant: Woodward, Inc., Fort Collins, CO (US)

(72) Inventors: Clayton S. Jacobs, Fort Collins, CO (US); Kevin Emery Wilson, Fort Collins, CO (US); Jason Chad Dunn, Fort Collins, CO (US)

(21) Appl. No.: 19/393,747

(22) Filed: Nov. 19, 2025

Related U.S. Application Data
(60) Provisional application No. 63/722,137, filed on Nov. 19, 2024.

(51) Int. Cl. F16K 1/226; F16K 1/22; H01M 8/04089; H01M 8/04746

(52) U.S. Cl. CPC F16K 1/2261; F16K 1/221; H01M 8/04104; H01M 8/04753

(57) ABSTRACT

An exemplary butterfly valve assembly generally includes a housing, a disc, and an actuator. The housing includes an inner wall defining a bore that extends along a longitudinal axis. The disc is mounted in the bore for pivotal movement about a pivot axis that extends transverse to the longitudinal axis. The disc includes a plate formed of a first material, and a seal surrounding a periphery of the plate and defining an outer edge of the disc. The seal is formed of a second material that is more flexible than the first material. The actuator is operable to pivot the disc about the pivot axis between an open position and a closed position. With the disc in the closed position, the outer edge is positioned adjacent the inner wall to thereby restrict flow through the bore. In certain forms, the butterfly valve assembly may be utilized to control intake airflow for a fuel cell and/or a genset.

### CROSS-REFERENCE TO RELATED APPLICATIONS

The present application claims priority to U.S. Provisional Ser. No. 63/722,137, filed Nov. 19, 2024, the contents of which are hereby incorporated by reference in their entirety.

### TECHNICAL FIELD

The present disclosure generally relates to butterfly valves, and more particularly but not exclusively relates to butterfly valves for use as throttle valves in fuel cell and/or genset applications.

### BACKGROUND

Fuel cells are often provided with an air inlet and a pair of valves to control the flow of air to the fuel cell via the air inlet. Some conventional systems utilize a butterfly valve as a throttle to adjust the rate of airflow into the fuel cell. However, these traditional butterfly valves are non-sealing and thus incapable of fully preventing airflow therethrough. As such, conventional fuel cell systems typically require a shutoff valve in addition to the throttle valve. While certain sealing butterfly valves have been proposed in other fields of endeavor, these valves often suffer from stiction that can render it difficult for the actuator to move the disc from the closed position. This is particularly problematic when torque is in limited supply, such as where low angle torquers are utilized.

In genset applications, a dedicated shut off valve is often provided with a butterfly valve to regulate flow of fuel or air to a genset or an engine coupled to an alternator. The dedicated shut off valve is designed to stop the fuel or air supply to the engine in the event of an emergency or when the generator is turned off. Providing independent shut offs to the air and gas prevents the engine from running even when one or the other is present, providing a redundant safety mechanism. In some applications, such as well heads or drill rigs, the fuel flow to the engine may not always stop when the engine is off, and preventing air flow to the engine ensures the engine cannot run. Some conventional engine control systems also utilize the butterfly valve as a throttle to adjust the rate of fuel flow and control engine speed and power. However, these butterfly valves are non-sealing and thus incapable of fully preventing flow therethrough. While certain sealing butterfly valves have been proposed in other fields of endeavor, these valves often suffer from stiction that can render it difficult for the actuator to move the valve plate from the closed position and/or negatively impact dynamic engine control, which may result in poor emissions. For these reasons among others, there remains a need for further improvements in this technological field.

### SUMMARY

An exemplary butterfly valve assembly generally includes a housing, a disc, and an actuator. The housing includes an inner wall defining a bore that extends along a longitudinal axis. The disc is mounted in the bore for pivotal movement about a pivot axis that extends transverse to the longitudinal axis. The disc includes a plate formed of a first material, and a seal surrounding a periphery of the plate and defining an outer edge of the disc. The seal is formed of a second material that is more flexible than the first material. The actuator is operable to pivot the disc about the pivot axis between an open position and a closed position. With the disc in the closed position, the outer edge is positioned adjacent the inner wall to thereby restrict flow through the bore. In certain forms, the butterfly valve assembly may be utilized to control fluid intake flow for a fuel cell and/or a genset. Further embodiments, forms, features, and aspects of the present application shall become apparent from the description and figures provided herewith.

### BRIEF DESCRIPTION OF THE FIGURES

FIG. 1 is a perspective illustration of a first butterfly valve assembly according to certain embodiments.

FIG. 2 is a perspective cutaway view illustrating a portion of the first butterfly valve assembly.

FIG. 3 is a perspective illustration of a portion of the first butterfly valve assembly.

FIG. 4 is an exploded assembly view of a disc according to certain embodiments.

FIG. 5 is a cross-sectional view of the disc illustrated in FIG. 4.

FIG. 6 is a cross-sectional illustration of the first butterfly valve assembly with the disc in a closed position.

FIG. 7 is a cross-sectional illustration of the first butterfly valve assembly with the disc in an open position.

FIG. 8 is an enlarged view of the inset labeled “8” in FIG. 6.

FIG. 9 is a plan view of a portion of the first butterfly valve assembly with the disc in the closed position.

FIG. 10 is a schematic illustration of a conventional fuel cell system.

FIG. 11 is a schematic illustration of a fuel cell system according to certain embodiments.

FIG. 12 is a perspective illustration of a second butterfly valve assembly according to certain embodiments.

FIG. 13 is a perspective cutaway view illustrating a portion of the second butterfly valve assembly illustrate.

FIG. 14 is a perspective illustration of a portion of the second butterfly valve assembly.

FIG. 15 is a cross-sectional view of the second butterfly valve assembly without the actuator.

FIG. 16 is an enlarged view of the inset labeled “16” in FIG. 15.

FIG. 17 is a plan view of a portion of the second butterfly valve assembly with the disc in the closed position.

FIG. 18 is a cross-sectional illustration of the second butterfly valve assembly with the disc in a closed position.

FIG. 19 is a top plan view of the portion of the second butterfly valve assembly with the disc in the closed position.

FIG. 20 is an enlarged view of the inset labeled “20” in FIG. 19.

FIG. 21 is a perspective view of the disc according to certain embodiments.

FIG. 22 is a cross-sectional view of the disc taken along the line 22-22 in FIG. 21.

FIG. 23 is a cross-sectional view of the disc taken along the line 23-23 in FIG. 21.

FIG. 24 is an enlarged view of the inset labeled “24” in FIG. 23.

FIG. 25 is a cross-sectional illustration of the second butterfly valve assembly with the disc in an open position.

### DETAILED DESCRIPTION OF ILLUSTRATIVE EMBODIMENTS

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Items listed in the form of “A, B, and/or C” can also mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

In the drawings, some structural or method features may be shown in certain specific arrangements and/or orderings. However, it should be appreciated that such specific arrangements and/or orderings may not necessarily be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may be omitted or may be combined with other features.

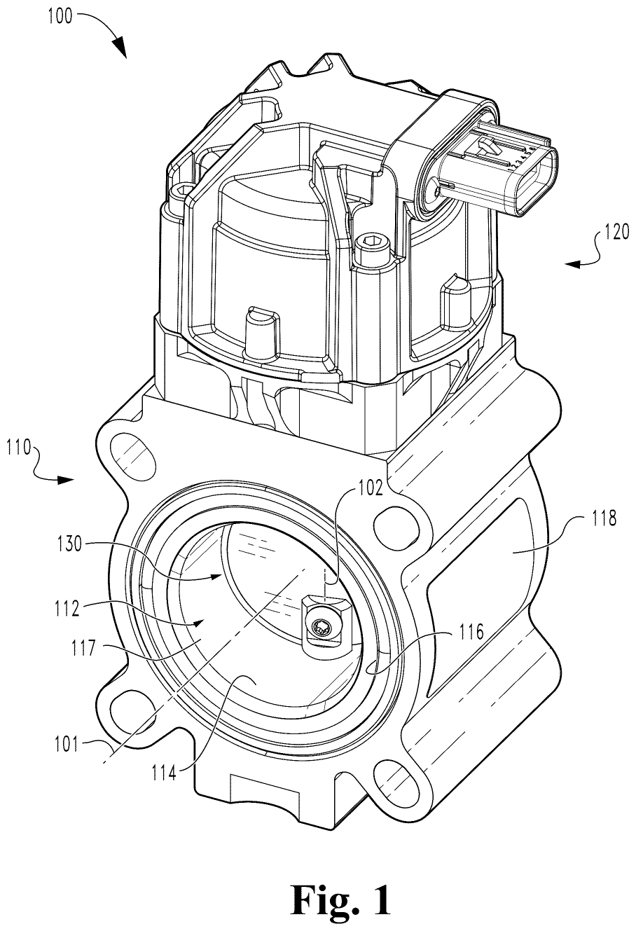

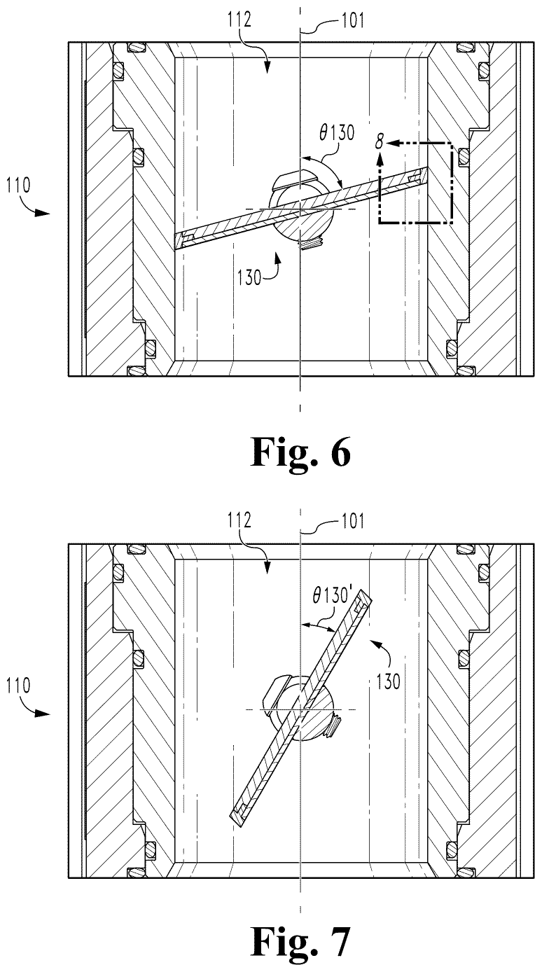

With reference to FIG. 1, illustrated therein is a butterfly valve assembly 100 according to certain embodiments. The valve assembly 100 generally includes a housing 110 that defines a bore 112, a disc 130 pivotably mounted in the bore 112, and an actuator 120 operable to pivot the disc 130 between a closed position (FIG. 6) and an open position (FIG. 7).

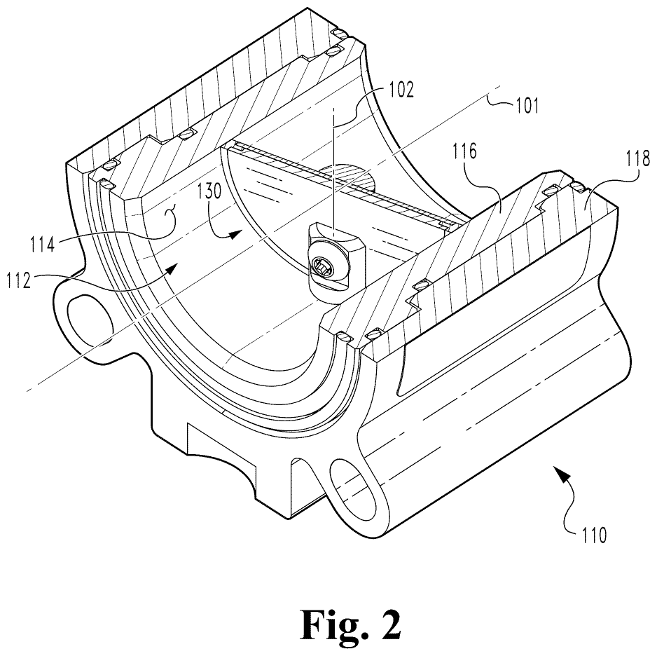

With additional reference to FIG. 2, the housing 110 defines the bore 112, which extends along a longitudinal axis 101 and is defined by an internal wall 114 of the housing 110. In the illustrated form, the housing 110 includes a sleeve 116 that is seated in a case 118. The sleeve 116 defines the internal wall 114, which in turn defines an inner profile 117 of the bore 112. In the illustrated form, the inner profile 117 has a circular geometry. However, it should be appreciated that other geometries may be utilized, including but not limited to elliptical geometries. In certain forms, the sleeve 116 may be formed of stainless steel, which can aid in controlling thermal expansion while providing a hard wear resistant surface. Additionally or alternatively, the case 118 may be formed of aluminum.

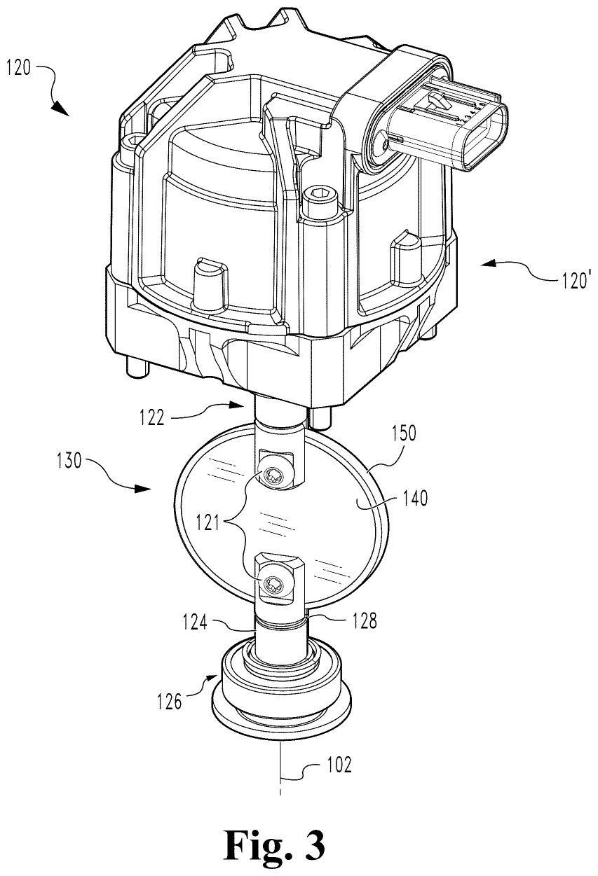

With additional reference to FIG. 3, the actuator 120 is operable to pivot the disc 130 about a pivot axis 102 between a closed position (FIG. 6) and an open position (FIG. 7). The pivot axis 102 extends transverse to the longitudinal axis 101 of the bore 112. In the illustrated form, the actuator 120 comprises a limited angle torquer 120′ operable to pivot the disc 130 between the closed position and the open position. The limited angle torquer 120′ may be operable to pivot the disc 130 through a limited angular range, such as one of about 60°. The limited angle torquer 120′ may be operable to place the disc 130 in each of a plurality of intermediate positions between the open position and the closed position. While the illustrated actuator 120 comprises a limited angle torquer 120′, it is also contemplated that the actuator 120 may take another form, such as one including a motor, a solenoid, and/or another form of actuator operable to pivot the disc 130 about the pivot axis 102.

While other forms are contemplated, in the illustrated embodiment, the actuator 120 comprises a shaft 122 that is coupled to the disc 130, for example via one or more fasteners 121. The actuator 120 is operable to rotate the shaft 122 to thereby rotate the disc 130 about the pivot axis 102. In certain forms, the shaft 122 may extend along a rear side of the disc 130 such that a distal end portion 124 of the shaft 122 extends out of the bore 112 and into the housing 110. A rotational support device 126 (e.g., a bushing or bearing) may be mounted in the housing 110 to rotatably support the distal end portion 124 of the shaft 122. A rotary shaft seal 128 (e.g., a U-cup seal) may be mounted to the distal end portion 124 to thereby seal off the rotational support device 126 from the bore 112.

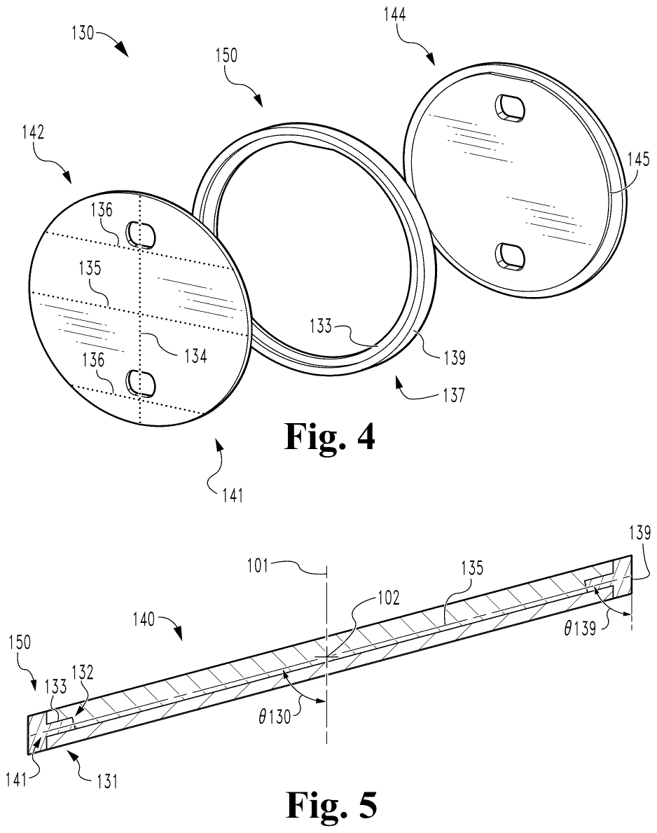

With additional reference to FIGS. 4 and 5, the disc 130 is pivotably mounted in the bore 112 for pivotal movement about the pivot axis 102. While other forms are contemplated, in the illustrated form, the disc 130 generally includes a plate 140 and a seal 150 disposed about a periphery 141 of the plate 140. The disc 130 may further include a mating engagement 131 through which the plate 140 is engaged with the seal 150. As used herein, a mating engagement generally includes a mater and a pater operable to be received by the mater. A mater may define a negative space, such as a slot, channel, groove, opening, cavity, or recess, and a pater may define a positive space, such as a tab, a finger, a tongue, or a ridge. In the illustrated embodiment, the mating engagement 131 generally includes a mater 132 defined by the plate 140 and a pater 133 defined by the seal 150. It is also contemplated that this arrangement may be reversed such that the seal 150 defines a mater that receives a pater defined by the plate 140. In certain forms, the seal 150 may be over-molded onto the plate 140.

In certain embodiments, the disc 130 may be provided with the geometry of a closed conical section or a closed cylindrical section, such as a circle or an ellipse. Those skilled in the art will readily appreciate that the precise configuration of the disc 130 may vary according to the geometry of the bore 112 and the oblique angle θ130 that the disc 130 defines relative to the longitudinal axis 101 when the disc 130 is in its closed position. While other forms are contemplated, in the illustrated embodiment, the bore 112 is circular, and the disc 130 is generally elliptical. The elliptical disc 130 has a minor axis 134 extending along the pivot axis 102 and a major axis 135 that extends in a lateral direction perpendicular to the pivot axis 102 and the minor axis 134. The disc 130 also has a plurality of lateral chords 136, each of which extends along the disc 130 in the lateral direction perpendicular to the pivot axis 102 and the minor axis 134. Stated another way, the lateral chords 136 are parallel to the major axis 135. In certain forms, the major axis 135 may be considered to define one of the lateral chords 136.

The disc 130 has an outer profile 137 that is defined by an outer edge 139 of the disc 130. The disc 130 is configured such that when the disc 130 is in its closed position, the outer profile 137 of the disc 130 matches the inner profile 117 of the bore 112. Stated another way, when the disc 130 is in the closed position and observed in a plan view along the longitudinal axis 101, the inner profile 117 of the bore 112 and the outer profile 137 of the disc 130 are substantially congruent with one another, for example as illustrated in FIG. 9.

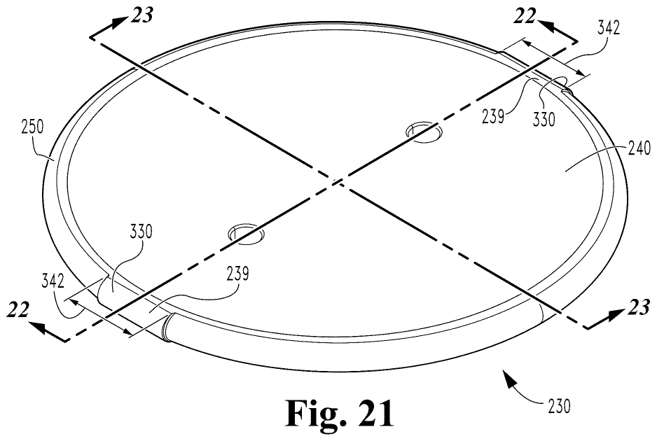

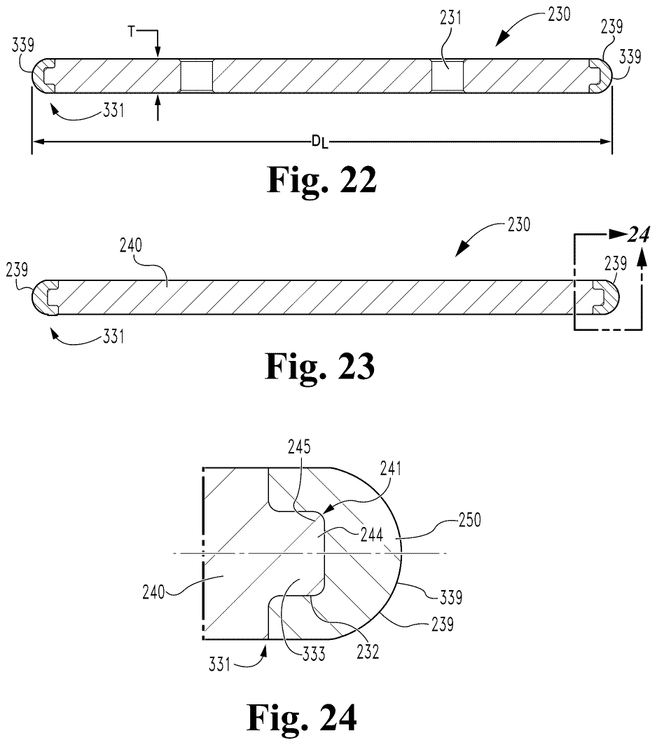

In the illustrated form, the outer edge 139 of the disc 130 is a flat outer edge 139. As used herein, the term “flat outer edge” indicates that a cross-section of the disc 130 taken along a laterally-extending line (e.g., the major axis 135 or a lateral chord 136) reveals the edge 139 as straight, for example as illustrated in FIG. 5. Thus, while the outer edge 139 is curved about the longitudinal axis 101, the outer edge 139 may nonetheless be referred to as “flat” as that term is used herein. In the illustrated embodiment, the flat outer edge 139 is defined by the seal 150. It is also contemplated that the outer edge 139 may instead be defined by a plate, for example in embodiments in which the seal 150 is omitted. Moreover, while the illustrated embodiment utilizes a flat outer edge 139, it should be appreciated that other configurations are contemplated, including those with a rounded cross-section, for example as described herein with reference to the butterfly valve assembly 200 illustrated in FIGS. 12-25. As described herein, however, the flat configuration of the illustrated outer edge 139 may provide one or more advantages that may be obviated by the use of a rounded geometry.

In the illustrated form, the plate 140 is provided as a split plate including a first section 142 and a second section 144 that facially abuts the first section 142. One of the sections 142, 144 (e.g., the second section 144) includes a shoulder 145 that partially defines the mater 132 when the plate sections 142, 144 are place in abutment. It is also contemplated that the mater 132 may be defined in another manner. For example, the plate 140 may be an integrally formed plate in which the mater 132 is milled out from the edge of the plate 140. Moreover, in embodiments in which the plate 140 defines a pater, the pater may be provided as an annular flange or ridge that extends out from a periphery 141 of the plate 140.

The seal 150 is disposed about the periphery 141 of the plate 140 and may aid in fluidically sealing the bore 112 when the disc 130 is in the closed position. In the illustrated form, a radially inner side of the seal 150 defines the pater 133, which projects into the mater 132 to define the mating engagement 131. It should be appreciated, however, that the inner periphery of the seal 150 may instead include a mater that receives a pater defined by the plate 140 to thereby define the mating engagement 131.

As noted above, the disc 130 defines a first oblique angle θ130 relative to the longitudinal axis 101 of the bore 112 when the disc 130 is in its closed position. In the illustrated form, the seal 150 defines the flat outer edge 139 of the disc 130, and the flat outer edge 139 defines a second oblique angle θ139 relative to a lateral chord 136, such as the major axis 135. The first oblique angle θ130 may alternatively be referred to herein as the disc closed angle θ130, and the second oblique angle θ139 may alternatively be referred to herein as the edge angle θ139. As described herein, the first oblique angle θ130 and the second oblique angle θ139 correspond to one another such that the flat outer edge 139 extends along the inner wall 114 when the disc 130 is in its closed position. In certain embodiments, the angles θ130, θ139 may correspond to one another, for example by being within 5° of one another, such that the flat outer edge 139 extends along the inner wall 114 when the disc 130 is in its closed position. In certain embodiments, the angles θ130, θ139 may match one another, for example by being within 0.5° of one another, such that the flat outer edge 139 is substantially parallel to the inner wall 114 when the disc 130 is in its closed position. In certain embodiments, the angles θ130, θ139 may be equal to one another such that the flat outer edge 139 is parallel to the inner wall 114 when the disc 130 is in its closed position. In the illustrated embodiment, the disc closed angle θ130 and the edge angle θ139 are equal to one another, and each has a value of about 75° (e.g., 75°±5°).

With additional reference to FIGS. 6 and 7, the actuator 120 is operable to pivot the disc 130 between a closed position (FIG. 6) and an open position (FIG. 7). In the closed position (FIG. 6), the disc 130 defines the disc closed angle θ130 relative to the longitudinal axis 101 and blocks the flow of fluid through the bore 112. When pivoted by the actuator 120 to the open position (FIG. 7), the disc 130 defines a disc open angle θ130′ relative to the longitudinal axis 101, and no longer blocks the flow of fluid through the bore 112. In the illustration of FIG. 7, the disc open angle θ130′ is about 30°. However, it should be appreciated that the disc open angle θ130′ may take other values. For example, in certain embodiments, the disc open angle θ130′ may be zero such that the disc 130 extends parallel to the longitudinal axis 101 when in the open position. Moreover, while not specifically illustrated, the disc 130 has a plurality of intermediate positions between the fully open position and the fully closed position, and the actuator 120 is operable to move the disc 130 to each of the intermediate positions. In certain forms, the actuator 120 may be operable to control the disc 130 with sub-degree granularity (i.e., to a continuous range of positions with a fidelity of 1° or less). Further details regarding the fidelity of a limited angle torquer are provided below with reference to the torquer 220′.

Those skilled in the art will readily appreciate that the torque required to pivot the disc 130 from the closed position (FIG. 6) to the open position (FIG. 7) depends upon a number of factors, including the amount of stiction generated between the seal 150 and the inner wall 114 when the disc 130 is in its closed position. The amount of stiction resisting pivoting of the disc 130 from the closed position in turn depends upon a number of factors, including the type of fit defined between the disc 130 and the wall 114, the materials selected for the wall 114 and the seal 150, and other factors. In certain circumstances, it may be preferable to reduce the stiction forces in an effort to reduce the amount of torque required to pivot the disc 130, for example to reduce the required output of the actuator 120. As described herein, this may involve appropriate selection of the fit defined between the disc 130 and the wall 114 and/or the materials selected for the wall 114 and/or the seal 150. In certain embodiments, the torque required to pivot the disc 130 from its closed position to its open position may be in the range of 0.2 to 0.5 in-lb (about 0.023 to 0.056 N-m).

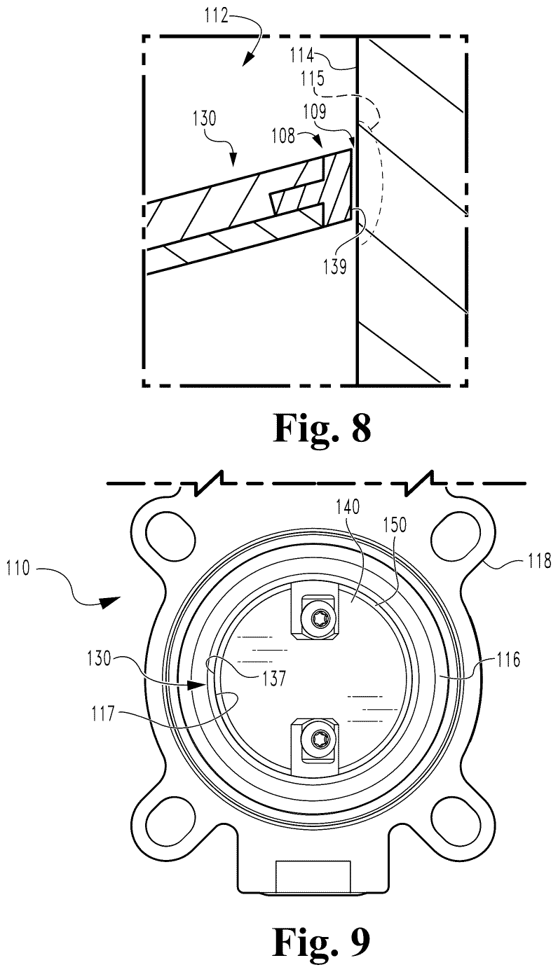

With additional reference to FIG. 8, in the illustrated form, the disc 130 and the bore 112 define a clearance fit 108 such that a gap 109 is formed between the flat outer edge 139 and the inner wall 114. The gap 109 may have a dimension on the order of one to ten thousandths of an inch (i.e., 0.001 inch to 0.01 inch), or in a range of one to two thousandths of an inch (i.e., 0.001 inch to 0.002 inch). In certain forms, the dimension of the gap 109 may be substantially constant (e.g., by varying less than 5%) along the direction of the longitudinal axis 101. In certain forms, the inner wall 114 may comprise a groove 115 that corresponds to the outer profile 137 of the disc 130 to provide further clearance for the outer edge 139 when the disc 130 is in its closed position.

While the illustrated embodiment includes a clearance fit 108 between the disc 130 and the wall 114, it is also contemplated that the disc 130 and the wall 114 may define another type of fit. In certain embodiments, the disc 130 and the wall 114 may define an interference fit such that the gap 109 is eliminated and the seal 150 is slightly compressed when the disc 130 is in its closed position. In certain forms, the disc 130 and the bore 112 may define a transitional fit such that the gap 109 is primarily eliminated but the seal 150 remains substantially uncompressed when the disc 130 is in its closed position. While an interference or transitional fit may provide for improved sealing when the disc 130 is in its closed position as compared to the clearance fit 108, it may nonetheless be desirable to sacrifice some degree of sealing in favor of the reduced stiction provided by the clearance fit 108.

As noted above, reduction of stiction may additionally or alternatively be facilitated by appropriate selection of materials for the wall 114 and/or the seal 150. One example material that may be appropriate for the wall 114 is stainless steel, which can aid in controlling thermal expansion and/or provide a hard wear-resistant surface for the seal 150 to abut. The seal 150 may be formed of any of a number of materials, which may be selected based on stiction criteria and/or wear resistance criteria. Example materials for the seal 150 include plastics and/or polymers such as synthetic rubber. In certain forms, the seal 150 may comprise polytetrafluoroethylene (PTFE), polyurethane, or a fluoroelastomer, such as Viton™.

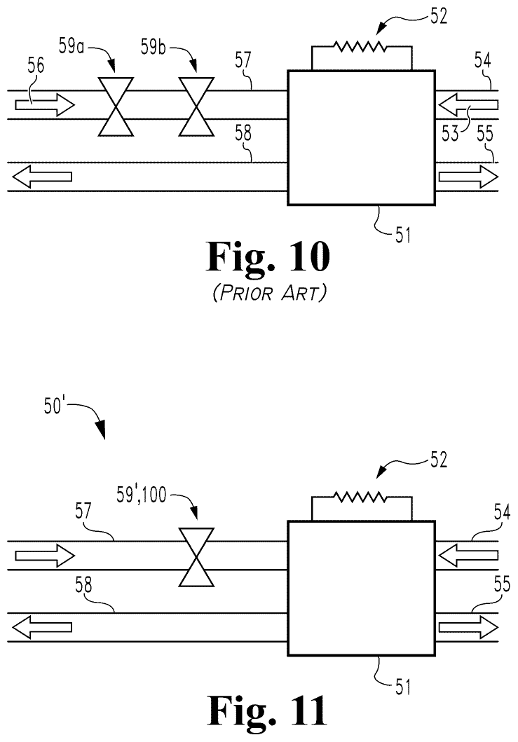

With additional reference to FIG. 10, illustrated therein is a conventional fuel cell system 50. The system 50 generally includes a fuel cell 51 operable to generate a voltage differential across a load 52. Fuel 53 flows into one side of the fuel cell 51 via a fuel inlet 54, and unused fuel 53 is discharged via a fuel exhaust outlet 55. Air 56 flows into the other side of the fuel cell 51 via an air inlet 57, and is discharged via an air exhaust outlet 58. Flow of air 56 through the air inlet 57 is controlled via a pair of valves, including a throttle valve 59a and a shutoff valve 59b. The throttle valve 59a modulates the flowrate of air 56 through the air inlet 57, and may be provided in the form of a conventional non-sealing butterfly valve. Because the throttle valves 59a used in conventional fuel cell systems 50 are unable to fully block the flow of air 56, the conventional system 50 requires a shutoff valve 59b in addition to the throttle valve 59a. The shutoff valve 59b selectively permits flow of air 56 through the air inlet 57, and is typically provided as a two-position open-close valve.

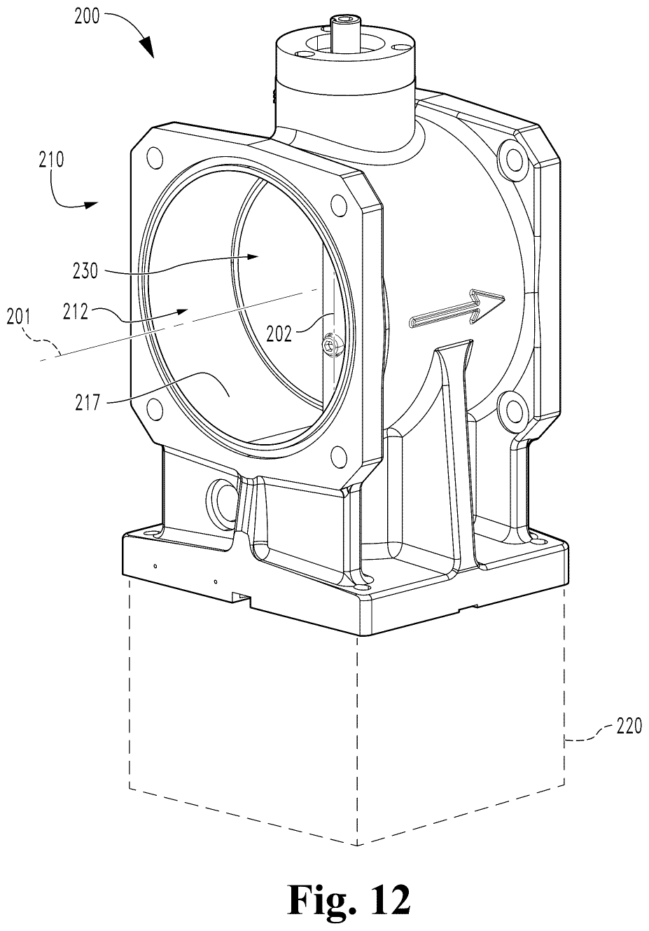

With additional reference to FIG. 11, illustrated therein is a fuel cell system 50′ according to certain embodiments. The fuel cell system 50′ is substantially similar to the conventional fuel cell system 50, and similar reference characters are used to indicate similar elements and features. Unlike the conventional fuel cell system 50, which requires both a throttle valve 59a and a shutoff valve 59b, the system 50′ utilizes a sealing butterfly valve 59′, which may be provided in the form of the butterfly valve assembly 100. Because the butterfly valve assembly 100 is operable to both modulate the flowrate of air through the bore 112 and selectively prevent flow of air through the bore 112, the need for two separate valves 59a, 59b has been obviated. Accordingly, the fuel cell system 50′ lacks a separate shutoff valve 59b.

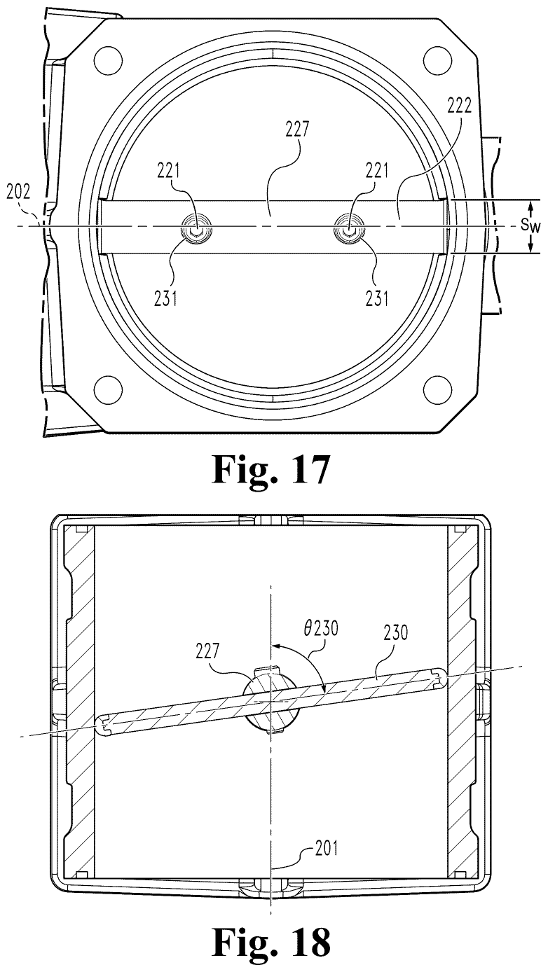

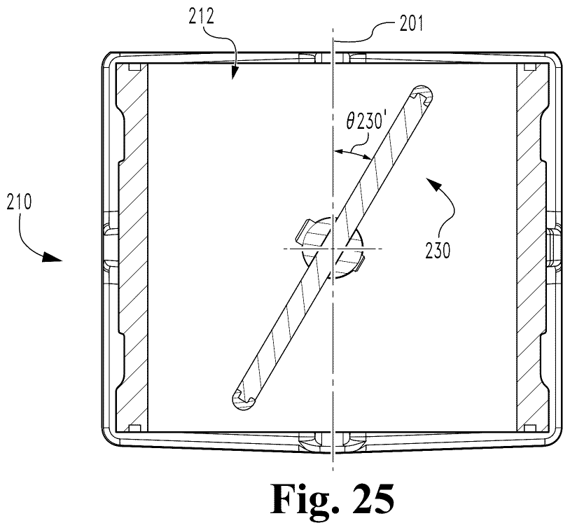

With reference to FIGS. 12-20, illustrated therein is a second butterfly valve assembly 200 according to certain embodiments. The second butterfly valve assembly 200 generally includes a housing 210 that defines a bore 212, a disc 230 pivotably mounted in the bore 212, and an actuator 220 operable to pivot the disc 230 between a closed position (FIGS. 17-19) and an open position (FIG. 25). The actuator 220 is illustrated schematically.

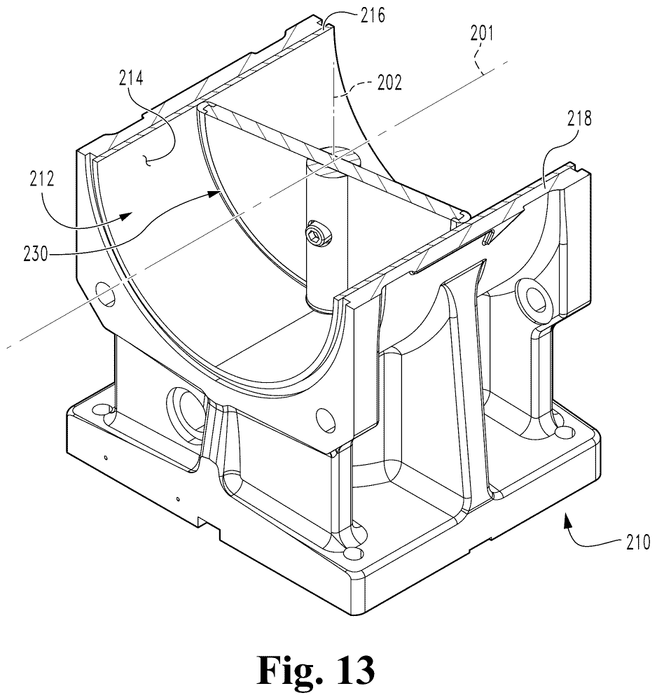

With specific reference to FIGS. 12 and 13, the housing 210 defines the bore 212, which extends along a longitudinal axis 201 and is defined by an inner wall 214 of the housing 210. In one embodiment, the housing 210 includes a sleeve 216 that is seated in a case 218. The sleeve 216 defines the inner wall 214, which in turn defines an inner profile 217 of the bore 212. In other embodiments, the sleeve 216 and the case 218 are a single monolithic piece. In the illustrated form, the inner profile 217 has a circular geometry. However, it should be appreciated that other geometries may be utilized, including but not limited to elliptical geometries.

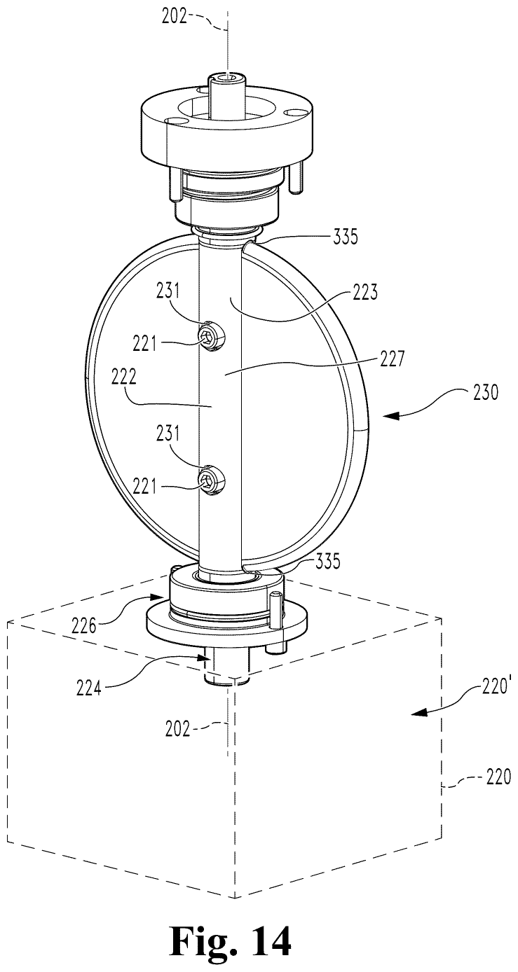

With additional reference to FIG. 14, the actuator 220 is operable to pivot the disc 230 about a pivot axis 202 between a closed position (FIGS. 17-19) and an open position (FIG. 25). The pivot axis 202 extends transverse to the longitudinal axis 201 of the bore 212. In one form, the actuator 220 comprises a limited angle torquer 220′ operable to pivot the disc 230 between the closed position and the open position and also pivot the disc 230 through a continuous range of positions between the open and closed positions with high positional accuracy. In other embodiments, the actuator 220 does not include the limited angle torquer 220′.

The limited angle torquer 220′ may be operable to pivot the disc 230 through a limited angular range, such as one of about 60°. The limited angle torquer 220′ may be operable to pivot the disc 230 to each of a plurality of intermediate positions between the open position and the closed position with high positional accuracy. The plurality of intermediate positions of the disc 230 is over a continuous range of positions such that the limited angle torquer 220′ can achieve any angle within the range while allowing smooth transitions without jitter or oscillation. In certain forms, the limited angle torquer 220′ controls the angle of rotation of the disc 230 to at least as accurate as 1° fidelity, preferably 0.1° or better, of angle of rotation. While the illustrated actuator 220 comprises a limited angle torquer 220′, it is also contemplated that the actuator 220 may take another form, such as one including a motor, a solenoid, and/or another form of actuator operable to pivot the disc 230 about the pivot axis 202.

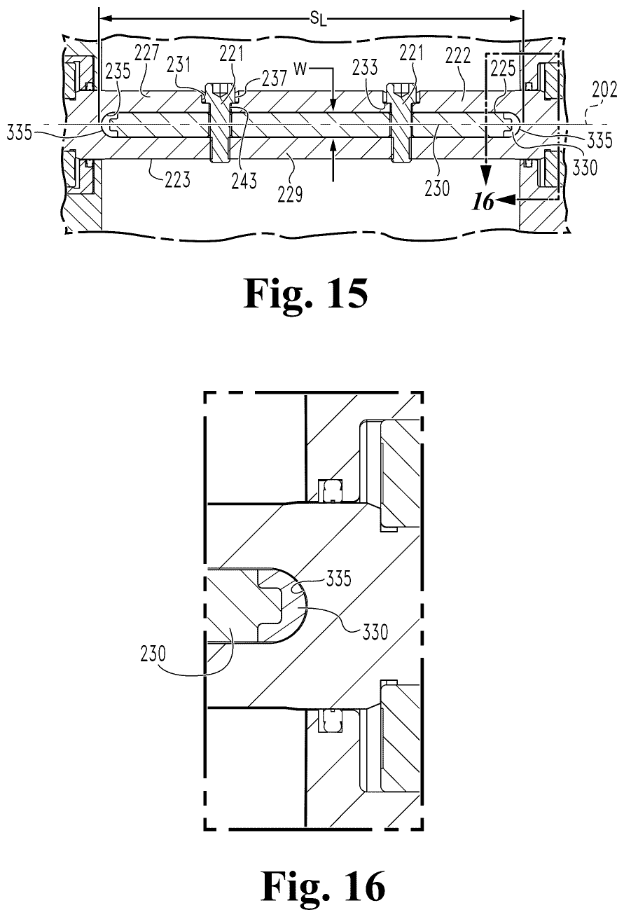

While other forms are contemplated, in the illustrated embodiment, the actuator 220 comprises a shaft 222 that is coupled to the disc 230, for example via one or more fasteners 221 as illustrated in FIG. 15. Each of the fasteners 221 includes a stem that extends from a head. The shaft 222 includes a shaft body 223 having a first shaft leg 227 separated from a second shaft leg 229 by a shaft slot 225 that extends along the pivot axis 202. The shaft slot 225 is sized to receive and retain a middle portion 260 of the disc 230, which middle portion 260 includes an overmold 330 as described below. The shaft slot 225 extends across a shaft width SW of the first and second shaft legs 227 and 229. The shaft slot 225 has a width W that corresponds to a thickness T of the disc 230. The shaft slot 225 has a slot length SL that corresponds to a disc length DL of the disc 230 relative to the middle portion 260, including the overmold 330. The shaft slot 225 includes a slot profile 235 that is defined by a slot edge 335 at both ends of the shaft slot 225. The slot profile 235 of the slot edge 335 is complementary to an outer profile 339 that is defined by an outer edge 239 of the disc 230 along the overmold 330 at the middle portion 260 as further defined below.

In the illustrated form, the shaft body 223 includes two counterbore holes 231 sized to receive the two fasteners 221 wherein each of the counterbore holes 231 extends through the first and second shaft legs 227 and 229. Each of the counterbore holes 231 includes a larger-diameter hole portion 237 and a smaller-diameter hole portion 243. The larger hole portion 237 is formed in the first shaft leg 227 and sized to receive a head of the fastener 221. The larger hole portion 237 only extends partially through the first shaft leg 227 therefore the larger hole portion 237 forms a shoulder 233 in the first shaft leg 227 to prevent the head of the fastener 221 from directly engaging or contacting the disc 230. Each of the counterbore holes 231 includes a smaller hole portion 243 that extends from the larger hole portion 237 in the first shaft leg 227 to the shaft slot 225 and through the second shaft leg 229. The smaller hole portion 243 is sized to receive the stem of the fastener 221, and may be threaded to threadedly engage a threaded portion of the stem of the fastener 221. The fasteners 221, when assembled with the counterbore holes 231 in the shaft 222, clamp the first and second shaft legs 227 and 229 to the disc 230 to fully retain the disc 230 to the shaft 222. In the event of a failure, this clamping arrangement of the fasteners 221 to the first and second shaft legs 227 and 229 discourages any pieces that might break off from entering the gas flow stream through the bore 212.

The actuator 220 is operable to rotate the shaft 222 to thereby rotate the disc 230 about the pivot axis 202. In certain forms, the shaft 222 extends along the pivot axis 202 of the disc 230 such that a distal end portion 224 of the shaft 222 extends out of the bore 212 and into the housing 210. A rotational support device 226 (e.g., a bushing or bearing) may be mounted in the housing 210 to rotatably support the distal end portion 224 of the shaft 222. In some embodiments, a rotary shaft seal 228 may be mounted to the distal end portion 224 to thereby seal off the rotational support device 226 from the bore 212.

With additional reference to FIGS. 12 and 17-24, the disc 230 is pivotably mounted in the bore 212 for pivotal movement about the pivot axis 202. While other forms are contemplated, in the illustrated form, the disc 230 generally includes a plate 240 and a seal 250 disposed about a periphery 241 of the plate 240. The disc 230 may further include a mating engagement 331 through which the plate 240 is engaged with the seal 250. As noted above, a mating engagement generally includes a mater and a pater operable to be received by the mater. In the illustrated embodiment, the mating engagement 331 generally includes a mater 232 defined by the seal 250 and a pater 333 defined by the plate 240. It is also contemplated that this arrangement may be reversed such that the plate 240 defines a mater that receives a pater defined by the seal 250. In certain forms, the seal 250 may be over-molded onto the plate 240.

In certain forms, the arrangement of the mater and pater may be selected based on utility. For example, providing the pater on the plate 240 and the mater on the seal 250 provides a secondary stiffness to the seal 250 when the disc 230 is closed. Providing the pater on the plate 240 may allow for increased sealing force of the disc 230 against the bore 212. It has been found that providing the pater on the plate 240 and the mater in the seal 250 can be less expensive to manufacture as compared to an O-ring or circular ring seal design. The pater on the plate 240 may provide extra surface area to adhere the seal 250 to the plate 240, and may discourage shearing and entry of sheared pieces to the gas stream. Providing the pater on the plate 240 may remove the primary shear force direction to better prevent wear-and-tear during operation of the disc 230. By contrast, providing the mater on the plate 240 and the pater on the seal 250 decreases the secondary stiffness of the seal 250 when the disc 230 is closed. Providing the mater on the plate 240 and the pater on the seal 250 can increase compliance between the seal 250 and the inner profile 217 of the bore 212.

In certain embodiments, the disc 230 may be provided with the geometry of a closed conical section or a closed cylindrical section, such as an ellipse. Those skilled in the art will readily appreciate that the precise configuration of the disc 230 may vary according to the geometry of the bore 212 and the oblique angle θ230 that the disc 230 defines relative to the longitudinal axis 201 when the disc 230 is in its closed position as illustrated in FIG. 18. While other forms are contemplated, in the illustrated embodiment, the bore 212 is circular, and the disc 230 is generally elliptical. In the illustrated form, the elliptical geometry of the disc 230 allows the disc 230 to seal tightly at a closed position; however, the disc 230 does not contact the inner profile 217 of the bore 212 at any other positions, which may aid in maintaining valve flow dynamics and position control dynamics throughout the entire travel of the disc 230.

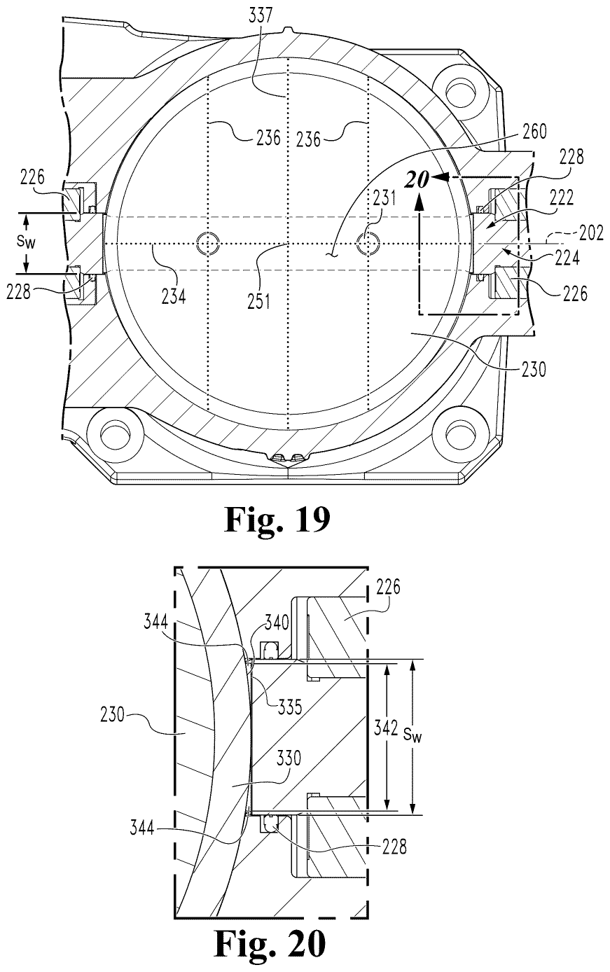

As illustrated in at least FIGS. 19-24, the elliptical disc 230 has a minor axis 234 extending along the pivot axis 202 and a major axis 337 that extends in a lateral direction perpendicular to the pivot axis 202 and the minor axis 234. The disc 230 has a center or midpoint 251 where the minor axis 234 and the major axis 234 intersect. The disc 230 also has a plurality of lateral chords 236, each of which extends along the disc 230 in the lateral direction perpendicular to the pivot axis 202 and the minor axis 234. Stated another way, the lateral chords 236 are parallel to the major axis 337. In certain forms, the major axis 337 may be considered to define one of the lateral chords 236. The illustrated disc 230 is symmetric about both the minor axis 234 and the major axis 237 such that the disc 230 has an elliptical shape. The disc 230 includes the middle portion 260 that spans along the minor axis 234 and the pivot axis 202. The middle portion 260 has a width that is about the same as or slightly less than the shaft width, SW, of the first and second shaft legs 227 and 229. The middle portion 260 is illustrated in FIG. 19 with dashed lines. The disc 230 includes a disc length DL as measured relative to the minor axis 234 and the pivot axis 202.

The disc 230 has an outer profile 339 that is defined by an outer edge 239 of the disc 230. The disc 230 is configured such that when the disc 230 is in its closed position, the outer profile 339 of the disc 230 engages or contacts the inner profile 217 of the bore 212. Stated another way, when the disc 230 is in the closed position and observed in a plan view along the longitudinal axis 201, the inner profile 217 of the bore 212 and the outer profile 339 of the disc 230 are substantially congruent with one another, for example as illustrated in FIG. 17. When the disc 230 is not in the closed position, the outer profile 339 of the disc 230 does not engage or contact the inner profile 217 of the bore 212.

In the illustrated form, the outer edge 239 of the disc 230 is a semicircular outer edge 239 except at the middle portions 260. As used herein, the term “semicircular outer edge” indicates that a cross-section of the disc 230 reveals the edge 239 is half of a circle, for example as illustrated in FIG. 24. In the illustrated embodiment, the outer edge 239 is defined by the seal 250. It is also contemplated that the outer edge 239 may instead be defined by a plate, for example in embodiments in which the seal 250 is omitted. Moreover, while the illustrated embodiment utilizes a semicircular outer edge 239, it should be appreciated that other configurations are contemplated, including those with a rounded cross-section or elliptical cross-section. As described herein, however, the configuration of the illustrated outer edge 239 may provide one or more advantages that may be obviated by the use of other geometries.

The semicircular design shape of the outer edge 239 on the plate 240 may provide for contact on the inner profile 217 of the bore 212 only when the disc 230 is at the closed position. In such forms, the outer edge 239 on the plate 240 does not contact the inner profile 217 of the bore 212 outside of the closed position, which may preventing negative impacts to flow dynamics or position control dynamics. This feature may be enhanced by the unique design of the shaft 222, in which first shaft leg 227 separated from the second shaft leg 229 by the shaft slot 225 and the shaft slot 225 is positioned in the middle of the shaft 222 such that the plate 240 passes through the center of the shaft 222. The slot profile 235 of the slot edge 335 is complementary to an outer profile 339 that is defined by an outer edge 239 of the disc 230 along the overmold 330 at the middle portion 260 to provide a tight seal at the ends of the plate and shaft interface to reduce flow between the shaft 222 and the plate 240.

In the illustrated form, the plate 240 is provided as a single plate. However, in other embodiments, the plate 240 may be a split plate including a first section and a second section that facially abuts the first section, for example as described above with reference to the plate 140. The plate 240 defines a pater 333 as an annular flange or ridge 245 that extends out from a periphery 241 of the plate 240. In other embodiments the plate 240 may be an integrally formed plate in which the mater is milled out from the edge of the plate 240.

The seal 250 is disposed about the periphery 241 of the plate 240 and aids in fluidically sealing the bore 212 when the disc 230 is in the closed position. In the illustrated form, a radially inner side of the seal 250 defines the mater 232 which receives the pater 333 to define the mating engagement 331. It should be appreciated, however, that the inner periphery of the seal 250 may instead include a pater that receives a mater defined by the plate 240 to thereby define the mating engagement 331. Providing the flexible seal 250 around a perimeter of the plate 240 may provide a tight seal across the valve as compared to a traditional butterfly valve.

The seal 250 includes the overmold 330 when the seal 250 is assembled with the plate 240. The illustrated overmold 330 includes a pair of extension portions 340 that are illustrated in FIG. 20. The pair of extensions 340 are substantially triangular in shape and extend to engage with the slot edge 335. The overmold 330 including the pair of extensions 340 have a length 342 that is about the same or slightly less than the shaft width, SW, of the shaft slot 225. The pair of extensions 340 fill a gap 344 formed between the outer profile 339 that is defined by the semicircular outer edge 239 of the disc 230 and the slot profile 235 of the slot edge 335. The pair of extensions 340 help to further restrict the internal area through which fluid can flow when the disc 230 is in the closed position. The pair of extensions 340 reduce potential flow paths which reduces possible leakage while the disc 230 is in the closed position.

The actuator 220 is operable to pivot the disc 230 between a closed position (FIGS. 17-19) and an open position (FIG. 25). In the closed position (FIG. 17-19), the disc 230 defines a disc closed angle θ230 relative to the longitudinal axis 201 and blocks the flow of fluid through the bore 212. When pivoted by the actuator 220 to the open position (FIG. 25), the disc 230 defines a disc open angle θ230′ relative to the longitudinal axis 201, and no longer blocks the flow of fluid through the bore 212. In the illustration of FIG. 25, the disc closed angle θ230 is about 75°, and the disc open angle θ230′ is about 30°. However, it should be appreciated that the disc open angle θ230′ may take other values. For example, in certain embodiments, the disc open angle θ230′ may be zero such that the disc 230 extends parallel to the longitudinal axis 201 when in the open position. In other embodiments, the disc open angle θ230′ corresponds to the disc 230 being in a position that the elliptic outer edge 239 does not contact the inner wall 214. As noted above, in the illustrated form, the disc open angle θ230′ is controlled by the actuator 220 through a continuous range of positions with a high degree of fidelity.

Those skilled in the art will readily appreciate that the torque required to pivot the disc 230 from the closed position (FIG. 17-19) to the open position (FIG. 25) depends upon a number of factors, including the amount of stiction generated between the seal 250 and the inner wall 214 when the disc 230 is in its closed position. The amount of stiction resisting pivoting of the disc 230 from the closed position itself depends upon a number of factors, including the type of fit defined between the disc 230 and the wall 214, the materials selected for the wall 214 and the seal 250, and other factors. In certain circumstances, it may be preferable to reduce the stiction forces in an effort to reduce the amount of torque required to pivot the disc 230, for example to reduce the required output of the actuator 220. As described herein, this may involve appropriate selection of the fit defined between the disc 230 and the wall 214 and/or the materials selected for the wall 214 and/or the seal 250. In certain embodiments, the torque required to pivot the disc 230 from its closed position to its open position may be in the range of 4 to 30 in-lb (about 0.45 to 3.4 N-m).

In certain embodiments, the disc 230 and the wall 214 may define an interference fit such that the seal 250 is slightly compressed when the disc 230 is in its closed position. In certain forms, the disc 230 and the bore 212 may define a transitional fit such that the seal 250 remains substantially uncompressed when the disc 230 is in its closed position. While an interference or transitional fit may provide for improved sealing when the disc 230 is in its closed position, it may nonetheless be desirable to sacrifice some degree of sealing in favor of the reduced stiction.

Reduction of stiction may additionally or alternatively be facilitated by appropriate selection of materials for the wall 214 and/or the seal 250. One example material that may be appropriate for the wall 214 is stainless steel, which can aid in controlling thermal expansion and/or provide a hard wear-resistant surface for the seal 250 to abut. The seal 250 may be formed of any of a number of materials, which may be selected based on stiction criteria and/or wear resistance criteria. Example materials for the seal 250 include plastics and/or polymers such as synthetic rubber. In certain forms, the seal 250 may comprise polytetrafluoroethylene (PTFE), polyurethane, or a fluoroelastomer, such as Viton™. The flexibility of the seal 250 prevents compression set and reduces variation in flow at low valve angles for the disc closed angle θ230 due to changes in seal geometry of the seal 250.

Because the butterfly valve assembly 200 is operable to both modulate the flowrate of fuel flow or air/fuel mixtures through the bore 212 and selectively prevent flow of fuel or air/fuel mixtures through the bore 212, the need for a shutoff valve can be obviated. Accordingly, the butterfly valve assembly 200 assembled with a genset lacks a separate shutoff valve when the butterfly valve assembly 200 is employed with the genset or an engine coupled to an alternator. By restricting the air flow enough to starve the engine, the butterfly valve assembly 200 can remove the need for a shutoff valve, which may reduce cost, weight, and space requirements even on direct-injection engine applications.

Certain embodiments of the present application relate to a butterfly valve assembly, comprising: a housing comprising an inner wall defining a bore that extends along a longitudinal axis; a disc mounted in the bore for pivotal movement about a pivot axis that extends transverse to the longitudinal axis, the disc comprising: a plate formed of a first material; and a seal surrounding a periphery of the plate and defining an outer edge of the disc, wherein the seal is formed of a second material that is more flexible than the first material; and an actuator operable to pivot the disc about the pivot axis between an open position and a closed position; wherein, with the disc in the closed position, the outer edge is positioned adjacent the inner wall to thereby restrict flow through the bore.

In certain embodiments, a shaft of the actuator defines a counterbore hole comprising a shoulder; and wherein the shaft is coupled with the plate via a fastener including a head that is received in the counterbore hole and engaged with the shoulder.

In certain embodiments, the fastener extends through the plate and further comprises a threaded portion that is opposite the head and engaged with the shaft.

In certain embodiments,, with the disc in the closed position, the outer edge is engaged with the inner wall to thereby seal the bore.

In certain embodiments, the outer edge has a flat cross-sectional geometry.

In certain embodiments, the outer edge has a curved cross-sectional geometry.

In certain embodiments, wherein the disc further comprises a mating engagement between the plate and the seal.

Certain embodiments of the current application relate to a butterfly valve assembly comprising a housing comprising an inner wall defining a bore that extends along a longitudinal axis; a disc mounted in the bore for pivotal movement about a pivot axis that extends transverse to the longitudinal axis, the disc having a lateral chord that extends along the disc in a direction orthogonal to the pivot axis; and an actuator operable to pivot the disc about the pivot axis between an open position and a closed position; wherein, with the disc in the closed position, the disc defines a first oblique angle relative to the longitudinal axis; wherein the disc has a flat outer edge that defines a second oblique angle relative to the lateral chord; and wherein the first oblique angle and the second oblique angle correspond to one another such that the flat outer edge extends along the inner wall when the disc is in the closed position.

In certain embodiments, the second oblique angle is within 5° of the first oblique angle.

In certain embodiments, the second oblique angle within 0.5° of the first oblique angle such that the flat outer edge is substantially parallel to the inner wall when the disc is in the closed position.

In certain embodiments, with the disc in the closed position, the flat outer edge and the inner wall define a clearance fit.

In certain embodiments, the disc comprises a plate and a seal about a periphery of the plate; and wherein the seal defines the flat outer edge.

In certain embodiments, the disc further comprises a mating engagement between the seal and the plate.

In certain embodiments, the seal is formed of a different material from the plate.

In certain embodiments, the inner wall is formed of stainless steel.

Certain embodiments of the present application relate to a system comprising the butterfly valve assembly, the system further comprising a fuel cell having an air inlet fluidically connected with the bore; wherein the butterfly valve assembly is operable to prevent airflow through the bore when the disc is in the closed position.

Certain embodiments of the present application relate to a butterfly valve assembly, comprising: a housing comprising an inner wall defining a bore that extends along a longitudinal axis, the wall defining an inner profile of the bore; a disc mounted in the bore for pivotal movement about a pivot axis that extends transverse to the longitudinal axis, the disc having a flat outer edge defining an outer profile of the disc; and an actuator operable to pivot the disc about the pivot axis between an open position and a closed position, wherein the disc defines an oblique angle relative to the longitudinal axis when the disc is in the closed position; wherein with the disc in the closed position, the outer profile of the disc matches the inner profile of the bore.

Certain embodiments of the present application relate to a butterfly valve assembly, comprising: a housing comprising an inner wall defining a bore that extends along a longitudinal axis; a disc mounted in the bore for pivotal movement about a pivot axis that extends transverse to the longitudinal axis, the disc has a minor axis that extends along the pivot axis, the disc has a major axis that extends in a lateral direction perpendicular to the minor axis, the disc is symmetric about both the minor axis and the major axis such that the disc has an elliptical shape, the disc having an outer edge that has a semicircular shape; and an actuator operable to pivot the disc about the pivot axis between an open position and a closed position; wherein, with the disc in the closed position, the semicircular outer edge of the disc engages the inner wall.

In certain embodiments, the disc comprises a plate and a seal about a periphery of the plate; and wherein the seal defines the semicircular outer edge.

In certain embodiments, the disc further comprises a mating engagement between the seal and the plate.

In certain embodiments, the seal is formed of a different material from the plate.

In certain embodiments, the seal includes an overmold that is located along the pivot axis.

In certain embodiments, the overmold includes a pair of extension portions.

In certain embodiments, the actuator includes a shaft having a shaft body with a first shaft leg separated from a second shaft leg by a shaft slot that extends along the pivot axis, the shaft slot is sized to receive and retain a middle portion of the disc and the overmold therein.

Certain embodiments of the present application relate to a butterfly valve assembly, comprising: a housing comprising an inner wall defining a bore that extends along a longitudinal axis, the inner wall defining an inner profile of the bore; a disc mounted in the bore for pivotal movement about a pivot axis that extends transverse to the longitudinal axis, the disc having a curved outer edge defining an outer profile of the disc; and an actuator operable to pivot the disc about the pivot axis between an open position and a closed position, wherein the actuator includes a shaft having a shaft body with a first shaft leg separated from a second shaft leg by a shaft slot that extends along the pivot axis, the shaft slot is sized to receive and retain a middle portion of the disc therein, wherein the disc defines an oblique angle relative to the longitudinal axis when the disc is in the closed position; wherein with the disc in the closed position, a portion of the outer profile of the disc contacts the inner profile of the bore.

In certain embodiments, the disc has an elliptical shape.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected.

It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A butterfly valve assembly, comprising:
a housing comprising an inner wall defining a bore that extends along a longitudinal axis;
a disc mounted in the bore for pivotal movement about a pivot axis that extends transverse to the longitudinal axis, the disc comprising:
a plate formed of a first material; and
a seal surrounding a periphery of the plate and defining an outer edge of the disc, wherein the seal is formed of a second material that is more flexible than the first material; and
an actuator operable to pivot the disc about the pivot axis between an open position and a closed position;
wherein, with the disc in the closed position, the outer edge is positioned adjacent the inner wall to thereby restrict flow through the bore.

2. The butterfly valve assembly of claim 1, wherein a shaft of the actuator defines a counterbore hole comprising a shoulder; and
wherein the shaft is coupled with the plate via a fastener including a head that is received in the counterbore hole and engaged with the shoulder.

3. The butterfly valve assembly of claim 2, wherein the fastener extends through the plate and further comprises a threaded portion that is opposite the head and engaged with the shaft.

4. The butterfly valve assembly of claim 1, wherein, with the disc in the closed position, the outer edge is engaged with the inner wall to thereby seal the bore.

5. The butterfly valve assembly of claim 1, wherein the outer edge has a flat cross-sectional geometry.

6. The butterfly valve assembly of claim 1, wherein the outer edge has a curved cross-sectional geometry.

7. The butterfly valve assembly of claim 1, wherein the disc further comprises a mating engagement between the plate and the seal.

8. A butterfly valve assembly, comprising:
a housing comprising an inner wall defining a bore that extends along a longitudinal axis;
a disc mounted in the bore for pivotal movement about a pivot axis that extends transverse to the longitudinal axis, the disc having a lateral chord that extends along the disc in a direction orthogonal to the pivot axis; and
an actuator operable to pivot the disc about the pivot axis between an open position and a closed position;
wherein, with the disc in the closed position, the disc defines a first oblique angle relative to the longitudinal axis;
wherein the disc has a flat outer edge that defines a second oblique angle relative to the lateral chord; and
wherein the first oblique angle and the second oblique angle correspond to one another such that the flat outer edge extends along the inner wall when the disc is in the closed position.

9. The butterfly valve assembly of claim 8, wherein the second oblique angle within 0.5° of the first oblique angle such that the flat outer edge is substantially parallel to the inner wall when the disc is in the closed position.

10. The butterfly valve assembly of claim 8, wherein, with the disc in the closed position, the flat outer edge and the inner wall define a clearance fit.

11. The butterfly valve assembly of claim 8, wherein the disc comprises a plate and a seal about a periphery of the plate; and
wherein the seal defines the flat outer edge.

12. The butterfly valve assembly of claim 11, wherein the disc further comprises a mating engagement between the seal and the plate.

13. The butterfly valve assembly of claim 11, wherein the seal is formed of a different material from the plate.

14. A system comprising the butterfly valve assembly of claim 1, the system further comprising a fuel cell having an air inlet fluidically connected with the bore;
wherein the butterfly valve assembly is operable to prevent airflow through the bore when the disc is in the closed position.

15. A butterfly valve assembly, comprising:
a housing comprising an inner wall defining a bore that extends along a longitudinal axis;
a disc mounted in the bore for pivotal movement about a pivot axis that extends transverse to the longitudinal axis, the disc has a minor axis that extends along the pivot axis, the disc has a major axis that extends in a lateral direction perpendicular to the minor axis, the disc is symmetric about both the minor axis and the major axis such that the disc has an elliptical shape, the disc having an outer edge that has a semicircular shape; and
an actuator operable to pivot the disc about the pivot axis between an open position and a closed position;
wherein, with the disc in the closed position, the semicircular outer edge of the disc engages the inner wall.

16. The butterfly valve assembly of claim 16, wherein the disc comprises a plate and a seal about a periphery of the plate; and
wherein the seal defines the semicircular outer edge.

17. The butterfly valve assembly of claim 17, wherein the disc further comprises a mating engagement between the seal and the plate.

18. The butterfly valve assembly of claim 17, wherein the seal is formed of a different material from the plate.

19. The butterfly valve assembly of claim 17, wherein the seal includes an overmold that is located along the pivot axis.

20. The butterfly valve assembly of claim 20, wherein the actuator includes a shaft having a shaft body with a first shaft leg separated from a second shaft leg by a shaft slot that extends along the pivot axis, the shaft slot is sized to receive and retain a middle portion of the disc and the overmold therein.
